(19) United States
(12) Patent Application Publication
(10) Pub. No.: US 2006/0036582 A1
(43) Pub. Date: Feb. 16, 2006

(54) Global search with local search

(76) Inventors: Laust Sondergaard, Palo Alto, CA (US); Anders Hyldahl, Virum (DK)

Correspondence Address: TRAN & ASSOCIATES, 6768 MEADOW VISTA CT., SAN JOSE, CA, 95135, US

(21) Appl. No.: 10/919,853

(22) Filed: Aug. 16, 2004

(51) Int. Cl. G06F 17/30

(52) U.S. Cl. 707/3

(57) ABSTRACT

A search system for enabling local searching via global searching includes a global search engine and a searchable global database storing information relating to web-pages on web-sites and base information relating to one or more web-sites, and a local search engine being accessible based on base information stored in the global database.

The present invention relates to searching a local web-site based on a search result from a global search.

### BACKGROUND

Today a portal search engine (a global search engine) can find a large number of documents to almost any query. The found documents can originate from a large number of different sources—different web-sites—from different companies, individuals and public entities.

Many users are interested in identifying all the found documents from a specific source, and some/many search portals do offer a function where the user can ask for the same query from only one source through a function called “MORE” or “SIMILAR PAGES”. In this case the search portal delivers all documents from the search portal's own database with origin from this source.

FIG. 1A illustrates an exemplary search using an exemplary search engine known as Google™ with the term “mondosoft.” On the left side, a series of search results including URL links and a brief descriptive text is provided for each search result matching the query “mondosoft.” On the left side, a series of advertisements or sponsored links are provided.

In the search result section of FIG. 1A, the first search result reads as follows:
Mondosoft Enterprise Search engine
Mondosoft offers site search, search reporting and optimization for all web environments . . . . Try a Mondosoft site search and behavior analytics solution . . . . www.mondosoft.com/—25 k—Jul. 11, 2004—Cached—Similar pages

Upon clicking the “Similar pages” link, another search result page is shown in FIG. 1B. As shown therein, 29 similar items are located from Google's database as of that day. The number of documents is limited to what is already in the search portals database, the design of the Similar pages link is the design from the search portal, in this case Google's design, and the company has no control of what is presented, the order and priority of the presented material.

### SUMMARY

In a first aspect, a search system for enabling local searching via global searching includes:
a global search engine and a searchable global database storing information relating to web-pages on web-sites and base information relating to some or all of the web-sites,
a local search engine being accessible based on base information stored in the global database.

According to the first aspect of the present invention, the global search is performed in the global database. The term global search should preferably be construed in context with the term global database which is preferably a database storing information relating to a number of web-sites, such as storing information from and/or about a number of web-pages relating to said web-sites. Accordingly, a global search is preferably a search performed by use of the global search engine in the global database.

Preferably, a global database may be characterised in that its extension is varying, its control is lower (when compared to a local database) and in that its coverage is low. Comparably and preferably, a local database may be characterised in that its extension is fixed, its control is higher (when compared to a global database) and in that its coverage is high. The global database preferably originates from extending an existing database, or alternatively the global database may advantageously be two separate databases being linked.

Searching is to be understood in the present context as, at least, the process of finding matches between words in a search query and text stored in a database, and the process of interactively stepping through different levels of menus, intentionally, leading to a document meeting the search query. The last search example is for instance known in systems in which documents on a web-site are accessible in a directory structure manner and wherein a specific document is found by stepping through different levels of directories.

In the present content the terms web-pages and web-sites should be given their broadest possible meaning and therefore all aspects of the present invention are, at least, applicable for searching sites which are not linked in such a manner that no local search engine is demanded. Furthermore and additionally, a web-page is to be considered as a data item, being accessible by HTTP for instance, and a web-site is to be considered as a collection of data items, such as for instance product information. In this light, the terms web-pages and web-sites should not be construed based only solely on the present meaning of these terms.

One aim of the present invention is to enable searching on one such web-site. This aim has been met by including base information in the global database, where the base information is used in order to perform or in the process of performing a search on such a web-site, a local search.

The base information has such a character that it makes a local search engine accessible. It should be noted in the present content that the base information may have at least the following two characteristics:
In case(s) where a specific local search engine being different from the global search engine is to be used on a selected web-site, the base information relating to the local search engine has, such as type of the local search engine, URL is accessible, such as identifiable and/or executable.
In case(s) where the global search engine is applicable also on the selected web-site the base information states so.

Accordingly, the phrases global search engine and local search engine may be construed to mean one application instructed either to search the searchable global database or to search a selected web-site, or they may be construed to mean two different applications, e.g. one application for performing a global search and one application for performing a local search.

Furthermore, the global database may be one database where the base information is an entry or the global database may be two or more databases in which the base information and other information, such as web-pages, are linked.

Thereby a system is provided which can be used by a searcher (a user of the system) to easily elaborate a search on a local web-site. This is very advantageous as web-sites are often represented only by a small number of web-pages in the global database and if the searcher using prior art systems wants to elaborate a search in such cases, he is forced to manually go to the web-site of interest and if not forced to start up a local search engine, he has at least to retype his search string in order to perform the local search on the selected web-site.

According to the present invention, this repetition of instructions of search engines performed by the user has been rendered superfluous, as the local search engine is accessible based on the base information stored in the global database, which base information preferably is/are used for launching the local search engine whereby the need for manually logging on to the selected web-site and initiating the local search engine is no longer present.

In preferred embodiments of the system according to the present invention, the local search engine can be installed remote form the global search engine, such as installed on the same machine as the web-site being searchable by the local search engine.

Alternatively, the local search engine can be installed at the same location as the global search engine.

In preferred embodiments of the present invention the base information relating to a particular web-site is extracted from a file preferably being stored at said particular web-site. The moment of extracting said information typically depends on how the system is implemented. In a preferred embodiment the base information relating to a particular web-site is extracted during crawling of said particular web-site.

In preferred embodiments of the invention, the base information being extracted is preferably a path to a specific file on a web-page, which file may be either the local search engine itself, may contain information instructing the global search engine to be the local search engine or may be a link to another location for the local search engine.

This feature is very advantageous as the owner of the local web-site in this case only has to inform the administrator of the searchable global database to look at a specific location for some detailed information regarding searching his web-site whereby he may be able to change the search facilities on his web-site without informing the administrator of the searchable global database about such changes.

Preferably, the system according to the invention may further comprise means adapted to transfer a search query from the global search engine to a local search engine. Such a transfer renders it possible to automatically perform a local search based on the same search query as used during the global searching as the local search engine may be instructed to be launched with said search query.

In preferred embodiments of the present invention, the basic information relating to a particular web-site is extended to an existing global data. In these situations, the system may preferably be the outcome of adding the local search facility to an existing global search facility. Again, the global database so constructed may be one database or it may be more than one database being linked in a suitable manner.

In other preferred embodiments of the system according to the present invention, the search system may preferably also comprise means adapted to launch the local search engine. Such means is(are) preferably application means such as a program being able to perform the launching. The launching is preferably based on base information corresponding to the local search engine and is preferably initiated based on a response from a user of the global search engine.

Such a response may either be predefined or actively given by the user. In a preferred embodiment the predefined response may be a user profile, provided for instance by the user himself, predicating that the local search is to be continued by a local search engine on the web-site having most relevant hits. In this situation, the user interface could be equipped with a button like “continue local search based on your profile ?” which by clicking would launch the local search engine. The actively given response may preferably be an instruction given by the searcher to continue searching by the local search engine.

The search system according to the present invention may preferably also comprise means adapted to log each time the local search engine is launched, said logging preferably comprising storing of a local search engine identifying number. This feature is very important and valuable for instance in cases where payment for local searching is based on number of times a local search engine is launched as the feature enables logging of events. In this case also, the means is(are) preferably an application, such as a program.

In another very important embodiment, the local search engine is preferably adapted to redirect a user back to the global search engine after or during execution of the local search engine. This feature may make it possible for a searcher to go back to the global searching/the original search result obtained by the global search engine and continue the searching on other web-sites. In a further embodiment of the present invention the local search engine comprises means for linking a user back to the global search engine.

In this embodiment the local search engine comprises means for storing information enabling redirection of a user back to the local search and means for executing said information.

Alternatively and/or more specifically, the global search engine may be adapted to pass a global search result on to the local search engine. In this case, the search result being passed on to the local search engine comprises base information relating to some or all of the web-sites being present in a global search result, whereby this search result may be made available during local searching, for instance for continued local searching without going back to the global search engine.

In this and other specific embodiments the local search engine may be adapted to pass the global search result received from the global search engine on to another local search engine.

In a particular embodiment, the base information relating to a particular web-site preferably comprises the path to said web-site and an executable statement which upon execution initiates the local search engine relating to said web-site, said executable statement preferably including the path to the local search engine.

In another aspect of the present invention a method for generating a searchable global database is provided. The database is particularly useful in a process of carrying into effect local searching on a web-site and the method comprises generating and storing in a memory or a storage medium of a computer base information relating to at least one web-site, said base information providing accessibility to a local search engine corresponding to a web-site.

Also in this aspect and in the following, the meaning of for instance the phrase local search engine is preferably to be found in the effect provided by the search engine. For instance, the local search engine and a global search engine may be one and same application just performing either a search in a searchable global database or performing a search on a selected local web-site.

Accordingly, the base information may be information leading directly to launch of a local search engine or it may be a path to a file/document comprising more detailed information relating to launching of said local search engine optionally also including instruction enabling the local search engine to be launched.

In a preferred embodiment the generated information is stored so that base information corresponding to a particular web-site is linked to information relating to web-pages on that particular web-site. More specificly, the linking is preferably provided by extending base information relating to a particular web-site to other information relating to web-pages on that particular web-site.

In another preferred embodiment of this aspect, generation of base information corresponding to a particular web-site comprises extracting said base information during crawling of the web-site.

In yet another aspect of the present invention a searchable global database is provided. The database which is useful in a process of carrying into effect local searching on a web-site, storing base information relating to at least one web-site, said base information providing accessibility to a local search engine corresponding to a web-site.

The searchable global database according to the present invention is preferably stored in a memory or a storage medium of a machine and/or system and/or computer and/or network.

Preferably the searchable global database is stored in the memory or storage medium in such a way that it is accessible for deduction of base information relating to a particular web-site.

In another aspect, the present invention also relates to a machine and/or system and/or computer and/or network comprising a memory or storage medium in which the database according to the present invention is stored.

In yet another aspect of the present invention a method of carrying into effect local searching on a web-site based on a global search result is provided. The global search result comprises, such as comprising a link to, base information relating to execution of a local search engine adapted to perform a search on a web-site and the method comprises
identifying base information relating to a particular web-site, said identifying being preferably based on and initiated by a response provided by a user of the global search engine, for instance in the form of a click on a button,
executing the identified information thereby causing execution of the local search engine.

In preferred embodiments of the method, identification of base information comprises extracting said information from a searchable global database.

Preferably, the execution of the identified information comprises supplying the local search engine with a search query, preferably such as a search query having provided the global search result.

The method according to the present invention may preferably further comprise the step of passing a global search result on to the local search engine.

Furthermore, the method may preferably also comprise the step of launching a global search engine after or during execution of a local search engine.

In preferred embodiments of the method according to the present invention, the method may further comprise the step of logging, preferably in a file, each time a local search engine is launched, said logging preferably comprising storing of a local search engine identifying number.

Advantages of the system may include one or more of the following. By hanging the “MORE” function on the search portal, to link the company's own search function with a request string including the original search query a number of advantages will be achieved, such as
All documents this company intends to present will be presented in the updated and required order, design, categorisation etc.
The search portal will be able to charge the companies for this function, to market the functionality, to brand it, and to gain competitive advantages over their competitors.
Easy launching of a local search engine is achieved, e.g. the user does not need to do any difficult submission of instructions for performing a local search.

### BRIEF DESCRIPTION OF THE DRAWINGS

The foregoing and other objects, features and advantages of the present invention will be apparent from the following detailed description of the preferred embodiments of the invention, reference being made to the accompanying drawing, in which like reference numerals indicate like parts and in which:

FIGS. 1A-1B show prior art search screens.

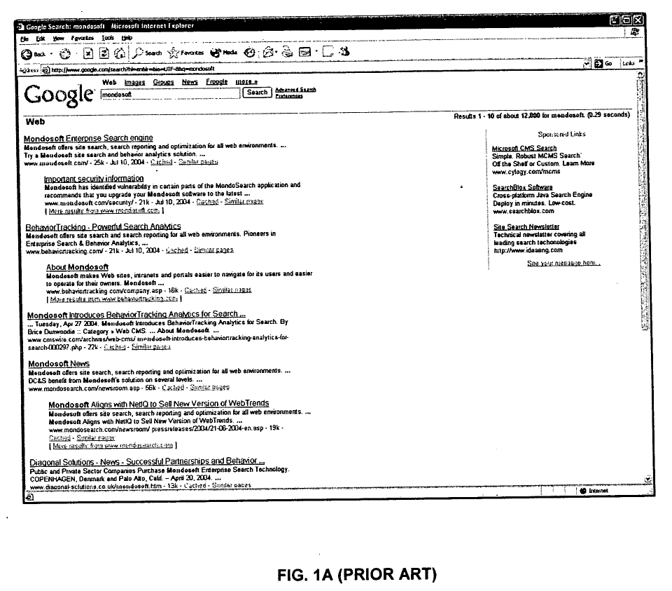

FIG. 2A shows an exemplary search system.

FIG. 2B shows an exemplary local server system.

FIG. 3 shows an exemplary embodiment of an information manager module.

FIG. 4 shows an exemplary process to respond to a page request from a referrer.

FIG. 5 shows an operation in FIG. 4 in more detail.

### DESCRIPTION

Although the following detailed description contains many specifics for the purposes of illustration, anyone of ordinary skill in the art will appreciate that many variations and alterations to the following details are within the scope of the invention. Accordingly, the following preferred embodiment of the invention is set forth without any loss of generality to, and without imposing limitations upon, the claimed invention.

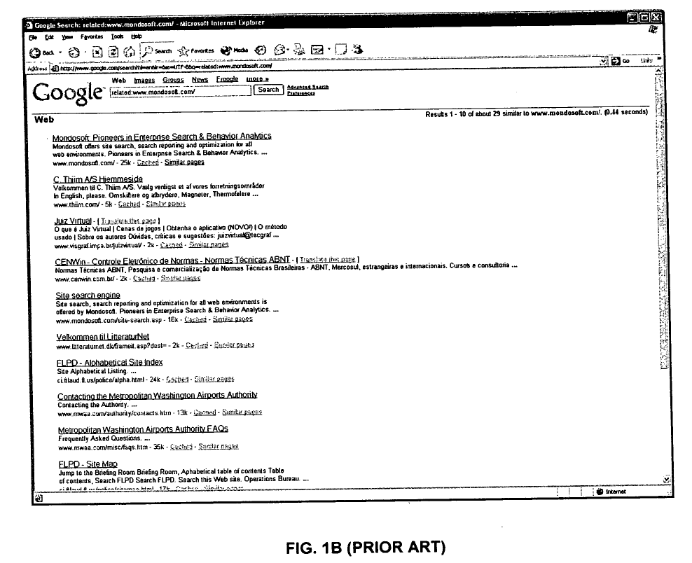

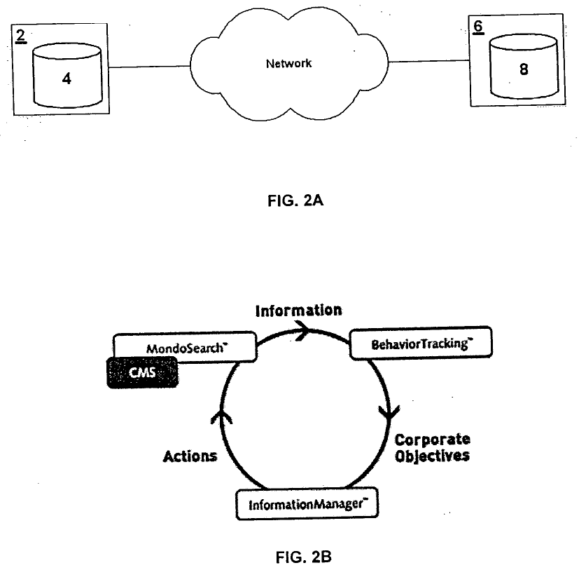

FIG. 2A shows one embodiment of a search system 1. The search system 1 includes:
A global search engine 2 having a corresponding database 4. The search engine 2 is able to search for information on a large number of web-sites, i.e. the database 4 comprises information relating to the content of web-pages and the locations thereof on a large number of web-sites. Furthermore, the database 4 stores information relating to search engines applicable on the web-sites being stored if such search engines are available. Such information is preferably a path to the actual location of the search engine on the web-site.
A local search engine 6 having a local database 8. This local search engine may be installed on either the hardware on which the corresponding web-site is located or it may be installed on the hardware on which the global search engine is installed on—or it may be installed on yet another hardware. Accordingly, the term local does not refer to the location of the search engine but its ability to perform local search.

The global and the local search engines are linked. This aim has been met by adding space for and storing information relating to the local search engines in the global search engine's database. This information is presented in relation to presenting a search result obtained by applying the global search engine.

The actual presentation of said information may include a conversion of the information so that the information is easily understandable. For instance, if a global search result includes web-sites being local searchable, then a button named “continue search on local web-site” may be presented an if this button is clicked, the local search engine is executed. Thereby the search may be repeated on the local web-site.

If the local search engines allows passing of search queries the search query used in the global search is passed on to the local search engine.

Today all global search engines have in their corresponding databases a table comprising all web-sites from which the search engine can deliver results. Also all search engines, typically, use slightly different search methods. Among all these different local search engines a subset exists comprising search engines searching by submitting an internet-call (via the HTTP-protocol or another well defined internet communication protocol) to the internet server on which the local search engine is installed. Not all local search engines are executable via the internet but the ones being executable via the internet are the ones most easily incorporated in the invention.

In order to implement the system, an existing global search engine is typically modified, which modification includes extending the global search engine's database with information pertaining to the local search engine(s) being affiliated to each web-site. This information renders it possible to provide a possibility for local searching for some of the hits provided by the global search engine.

The information (registration) extended to the global search engine's web-site table pertains to how a local search engine is called, whether it is present/is registrated/is workable etc. The information may be entered into the web-site table either manually, automatically or by a combination of both, but in all cases personnel prescribes how the local search engine is called, for instance by prescribing a string like “http://search.shares.com/cgi-bin/MsmFind.exe?query=<Here-must-the-search-words-be-placed>” combined optionally with additional information.

Automation of the process of extending such information is preferably performed by placing a file in the root of the web-site, in which file the above described string (“http://search . . . ”) is present. As web-sites normally have a file, robots.txt, already placed in the root of the web-site and used by the worm during the crawling process, extension of this string will provide a system in which the information to be extended to the global web-site table is gathered during the crawling process.

Alternatively—or supplementary—if the global search engine does not already comprise an interface for inputting information relating to a new web-site, in the sense that information does not already exists, such an interface is added, whereby the global search engines at the next crawl also visit such new web-site(s). This interface is extended so that the string “http://search . . . ” can be input to the global search engine.

Yet another alternative—or supplement—is that the owner of the global search engine contacts owners of the web-sites already being present in the global search engine's web-site table and offers them the possibility of local search via global search. If accepted, the personnel administrating the global search engine manually modifies/extends the global search engine's database accordingly, i.e. add the information pertaining to local search to that database.

Further information may be extended. Such further information may be of either technical character, such as search variants, sorting, ways of appearance, icon, text or the like, or it may be of businesses character, such as payment, subscription, term to expire etc. or a combination of those.

FIG. 2B shows an exemplary web site system that enables enterprises to perform effective online dialog with customers over the Internet. The system works with content management systems and is based on three interoperating modules which provide a high degree of synergy with each other and help make information a more valuable asset. The interoperating modules include a search module 10, a behavior tracking module 20, and an information manager module 30.

The search module 10 provides overview of information to end-users, as well as to site owners through the behavior tracking module 20. Behavior tracking makes it easy to see how content could be improved and how products, services or information should target user needs. The actions are applied and aligned to corporate strategies with the information 30 manager module 30.

In one embodiment, the search module 10 is MondoSearch™, a multi-lingual enterprise search engine from Mondosoft of Palo Alto, Calif. MondoSearch delivers categorized search results in context, so users will know what is relevant to them. The behavior tracking module 20 can be Mondosoft's BehaviorTracking™ which provides information to improve response quality and thereby business results. BehaviorTracking makes MondoSearch smarter with every visit because it tracks each search all the way through to its successful—or unsuccessful—conclusion and learns from visitors' behavior. The behavior tracking module 20 provides reports-on-demand that recommend what actions should be taken to improve sales, cut costs and retain customers, for example.

The information manager module 30 can be Mondosoft's InformationManager™ which provides a wealth of facts about visitors, and MondoSearch, which represents a site's tool for 10 interacting with users. InformationManager makes it easy to put the insight obtained via BehaviorTracking into tangible actions and improvements that provide users a great experience.

During operation, the search module 10 records data about the searches while serving the search requests. It then sends the recorded data to the behavior tracking module 20 that analyzes for interests, trends and needs, and feed the information to the site administrators, editors, marketing and management. The knowledge of user interests and behavior—arising from behavior tracking can be evaluated on a real-time basis and allow for constant refinement and recalibration of content to insure up-to-date and relevant information that meets visitor expectations. The information manager module 30 enables users to apply the knowledge obtained from the behavior tracking module 20 to improve the site usability and search success.

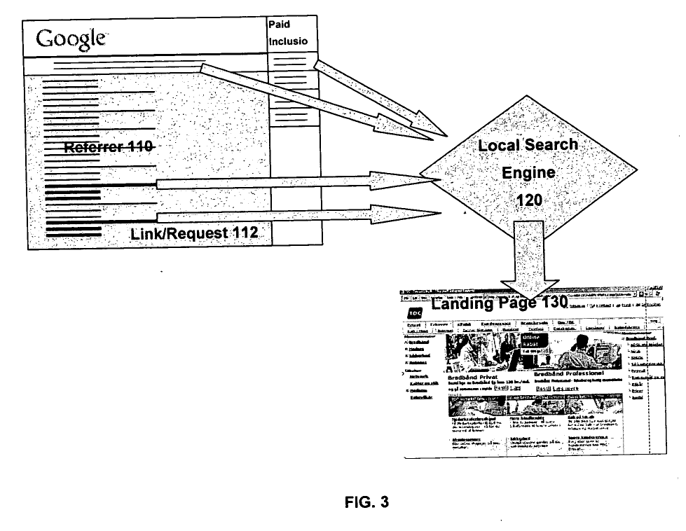

FIG. 3 shows an exemplary embodiment of an information manager module 30. When the user clicks on a link from the search engine, the search engine as a referrer sends a request to the company's web site. In one embodiment, the information manager module 30 receives a request 112 from a referrer 110 such as a search engine. Possible search engines can be search engines from Google, Yahoo, or MSN etc. Searching is to be understood in the present context as, at least, the process of finding matches between words in a search query and text stored in a database, and the process of interactively stepping through different levels of menus, intentionally, leading to a document meeting the search query. The last search example is for instance known in systems in which documents on a web-site are accessible in a directory structure manner and wherein a specific document is found by stepping through different levels of directories.

In the present context the terms web-pages and web-sites should be given their broadest possible meaning. Furthermore and additionally, a web-page is to be considered as a data item, being accessible by FTP for instance, and a web-site is to be considered as a collection of data items, such as for instance product information. In this light, the terms web-pages and web-sites should not be construed based only solely on the present meaning of these terms.

The request 112 is processed by a local search engine 120. The local search engine 120 decides the best documents that matches the request, in this case a landing page 130 and serves the landing page 130 as a response to the request 112. The landing page 130 can be determined by the behavior on the global search (i.e.) the search term used, profiling from CRM, previous user behavior, among others. The local search engine may alternatively provide a list of matching results, either in a layout similar to the global search engine or in a layout similar to the other pages on said website.

In FIG. 3, a user performs a search at a web site of the referrer 110 such as a search engine. Users can quickly evaluate the success of their query by checking a summary of the overall results. This should include a quick overview of how many pages were found, which search words were not found, which languages were found, among others. The summary can contain unique titles and descriptions for found pages based on page content.

The user clicks on a search result and is taken to a particular web page. The link or request 112 which includes referral source information is sent to the determiner 120. The determiner 120 looks up data in a business logic database (BLD) 150. The database 150 can be a relational database. Based on the result found in the BLD, the determiner 120 provides a link to a page that is responsive to the user's search. The page is part of a web site hosted by a company server such as that of FIG. 2B. Typically, the referrer's server is not under the control of the company server. The insertion of the determiner 120 between the referrer 110's web site and the company's web site allows content to be intelligently targeted to the user's search request. Thus, if the link from Google to the company's page is invalid, the determiner 120 can automatically redirect the user to a desired landing page or any suitable page the provides the user with information that the company wishes the user to view such as targeted marketing information or educational material, for example.

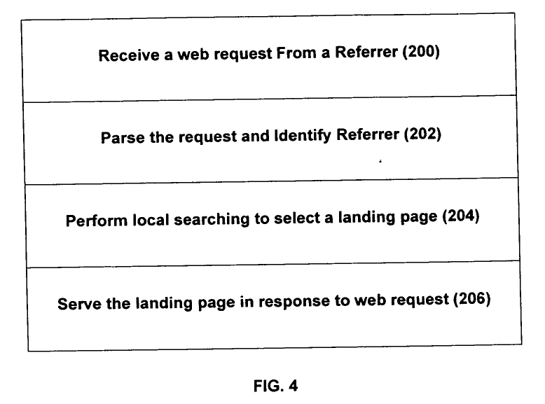

FIG. 4 shows an exemplary process to respond to a page request from a referrer. In this embodiment, the referrer is a search engine as discussed above. The process receives a web request from a referrer (200). The received request can conform to the URL format and preferably includes a referrer identification embedded in the request. The process parses the request and identifies the referrer (202). Based on the search request and the referrer identification, the process performs a local search for a predetermined page most responsive to the user's query (204). The responsive page can be a landing page, among others. The process then serves the landing page to the user in response to web request from the referrer (206). The landing page may present the list of results from the local search, part of said list or be directly or indirectly linked to the search terms. This can be determined solely by the local search engine or by other processes on the local web server.

In one embodiment, the process enables a web site with numerous URL changes to pages in the web site to automatically provide a local search in response to an invalid URL. Because the web-master changed the whole website and all the URLs (the exact page addresses)—visitors who entered an old invalid URL would have gotten an error known as a 404—page not found. In this case, the local search engine is used to automatically redirect visitors asking for a non existent page to the local search engine searching for some of the words in the URL.

Before the local search engine can find anything, the relevant information must first be loaded into a searchable database. This is normally done by a crawler program, which loads web pages and other types of documents just like a human reader does, saves the information into a database and then follows all of the links it finds. In this way, the crawler works its way through the entire web site until all of the information has been indexed. The crawler starts at the top of a web site, loads all of the information it finds into a database and stores a list of each link it sees; it then follows each new link and continues until the entire site has been indexed.

The database itself is optimized for searching and, as a result, does not resemble the original web site structure. It contains a list of found words and relates these to the specific pages and other found documents. The position of each word in each document is stored along with meta information about the document itself (e.g. document age, the context in which it appeared, document titles, document descriptions, related words, page language, etc.).

The database is optimized for searching local web pages. The database contains data to locate search term words and relates these to the specific pages and other found documents. The position of each word in each document is stored along with meta information about the document itself (e.g. document age, the context in which it appeared, document titles, document descriptions, related words, page language, etc.). In addition to search term data, the database also contains data to locate referrers or search engines, behavior of previous with same search term, user profiles, and search term clusters.

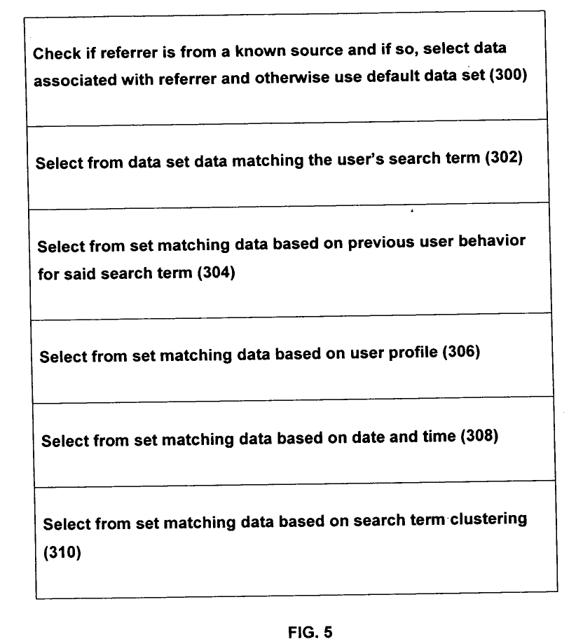

FIG. 5 shows one embodiment of operation 204. First, the process checks if the referrer is from a known source and if so, select data associated with referrer and otherwise the process uses a default data set (300). Thus, if the search came from Google, a set of data optimized for responding to requests from Google is selected. Next, the process selects from the prior data set data matching the user's search term (302). The process can then select from the data set matching data based on previous user behavior for said search term (304). Thus, if a number of prior searches indicate that a particular page is responsive, that page will be selected. Additionally, the process selects from the data set matching data based on user profile (306). Thus, if the user indicates that he or she is from a particular industry, the data set can be narrowed to the specific industry, for example. The process can also select from the data set matching data based on date and time (308). Additionally, the process can select from set matching data based on search term clustering (310).

In other embodiments, techniques for ensuring effective page response include intuitive query processing: When multi-word queries are used, pages including all words should rank highest. Pages where those words are close together should rank higher still. Further, by categorizing results, users can more easily match category names to the type of information they hope to find. The top hits from several categories can furthermore be displayed on a single page, thereby increasing the chance that the desired result page is listed there.

Additionally, the company can marry specific search words to the best pages and use these to increase the target page's ranking or to display targeted messages.

In this embodiment, the determination for relevance of each page is not sharply black or white, but some shade of gray that change according to the context of each search (fuzzy logic search). The system uses all of the information at its disposal when deciding how relevant a document is for each query. All matching pages are included in the search results, but the documents assigned the highest relevance ranking will be placed at the top of the list. By combining information stored in each document with the information submitted by the user, the system may consider some or all of the following factors when applying Fuzzy Sorting to determine the relevance of each document:
The position of a search word in the document
Number and order of matching search words in the document
The frequency of a search word in the document
The position of a search word in the query
Media specification
Document age

The Fuzzy algorithm helps the system in evaluating and presenting search results in context. It considers all information available, both in the query supplied by the user and for each page in the database, and furthermore considers the specific preferences of the site owner. In the query, it looks at each specific word and the order in which they were entered. Pages that have most or all of the query words are scored highly; those pages where the words are close to one another rank higher still and those with an actual matching phrase rank highest. On each page, the number of times that search words are used and the location in which they appear are considered. Therefore, pages that include search words in important positions such as the title, headings or key-words list would rank higher than pages where the words appeared only in the body text; pages that used a given search word many times would rank higher than those that used it only once; pages where a word appears near the top (a likely place for an introduction) will rank higher than pages where the word appears only near the bottom.

When evaluating phrases, the fuzzy sorting algorithm looks both for hard and soft matches—unless quotes are used in the query, in which case only hard matches are returned. A soft phrase match is one in which one or more additional words appear in between the query words. The match is softer still if the words are separated and/or in another order. For example, in a search for “heart medicine”, a document including the phrase “heart drugs and medicine” would be considered a relatively strong soft-phrase match; a document including “a heart shaped table is just the medicine for a dreary morning” would be a weak match; and a document titled “Choosing the Right Heart Medicine” would rank strongest as an example of a hard-phrase match in a high-value location.

The system can also search for matching landing pages based on META-tags placed on the company's pages. META-tags are used to characterize the content of the pages on which they appear. The most-common METAtags (such as for titles, keywords and descriptions) can be used in addition to two types custom ranking META-tags that give site owners extra control: rankwords and rank-document. Rank-words meta tags cause a page to be ranked at the top of its category when one or more of the words specified by this tag are included in a query. The effect is similar to the keywords META-tag, but rank words will have an even more significant effect. Rank-document META-tags influence a page's ranking (either up or down) every time the page is found, regardless of the submitted query. Other factors will still be considered as usual, so a document marked with a rank-document tag set to +2 is not guaranteed to appear at the top of the list every time, but it will be much more likely to do so. Another way to promote information is by creating a Top Hits category that is always listed first on the multi-category result page. Important pages that are assigned to the top hits category will appear whenever they are part of a result set.

Users expect the best content pages to be listed on the first result page. Techniques for ensuring effective page rankings include:
Intuitive query processing—When multi-word queries are used, pages including all words should rank highest. Pages where those words are close together should rank higher still.
Categorized results—By categorizing results, users can more easily match category names to the type of information they hope to find. The top hits from several categories can furthermore be displayed on a single page, thereby increasing the chance that the desired result page is listed there.
Site-owner intervention—With some search engines, site owners can marry specific search words to their best pages and use these to increase the target page's ranking, to display targeted messages or even to jump directly to the best match, skipping the result list all together.

In addition to effective rankings, the users themselves must be able to connect the pages they see listed with the information they are seeking. This requires that the result page provide useful and accurate summary information, including:

Search summary—Users can quickly evaluate the success of their query by checking a summary of the overall results. This should include a quick overview of how many pages were found, which search words were not found, which languages were found, etc.

Result of query: ‘Shares Microsoft’

| | | |
|---|---|---|
| 1 | Microsoft is selling out . . . | www.info.com |
| | New information about the last . . . | Search local on |
| www.info.com | | |
| 2 | Shares going up . . . | www.shares.com |
| | The rates on KFX . . . | Search local on |
| www.shares.com | | |
| 3 | IT industry will . . . | www.it.com |
| | Investments best . . . | Search local on |
| www.it.com | | |
| 4 | Microsoft will . . . | www.news.com |
| | Shares best . . . | |

Accurate titles and descriptions—Page authors should provide accurate and unique page titles and descriptions. These are the best description that users have about each page listed in search results. For sites that lack these, the search engine may be able to generate unique titles and descriptions based on page content.

### EXAMPLE

In a fictive global search engine the user searches for ‘Shares Microsoft’. This search is technically performed by calling in an internet browser:
http://www.global.com/search.cai?query=shares+microsoft

The global search engine returns the following result in the browser:

Apparently, no useable local search engine is registered on www.news.com, but useable search engines are registered on www.info.com, www.shares.com and www.it.com.

If the user decides to search locally on www.shares.com he just clicks on Search local on www.shares.com, which click effectuates the internet call:
http://search.shares.com/cgi-bin/MsmFind.exe?query=shares+microsoft

whereby the following result is returned from the local search engine:

Result of query: ‘Shares Microsoft’ - www.shares.com

| | | |
|---|---|---|
| 1 | Shares going up . . . | /kfx.html |
| | The rates on KFX . . . | |
| 2 | Microsoft knows . . . | /news/itm.html |
| | New information from the big . . . | |
| . . . | | |

During searching the user will most properly experience a situation where the local web-site visited via the global search result turns out to be uninteresting and the user wants to go back and use the global search and optionally continue investigating the global search result obtained at first hand.

In order to meet such a requirement the global search engine passes information on to the local search engine enabling the local search engine to redirect the user back to the global search engine. Preferably, the global search engine passes this information on to the local search engine when the user activates the local search engine and in cases where also the search string is passed on to the local search engine passing of all information is done at the same time.

The local search engine then receives the redirection information and stores that information until needed. At the local search engine's user interface a button like “go back to the global searching” appears which when clicked will cause execution of an application redirecting the user to the global search engine.

Alternatively, the global search result is stored in a file which is passed on to the web-site on which the local search engine is instructed to search. This file comprises information relating to how other local search engines are executed and if a user decides to perform searching on another web-site, the information relating to said web-site is extracted and executed initiating local searching on another web-site.

In another preferred embodiment of the present invention the method automatically redirects a global search to a local search engine. This means that the user does not have to push any buttons in order to continue searching on a local web-site. Different criteria for such automatically continuing searching locally are typically set up before the global search is executed. One such criterion is that the search is automatically continued at the web-sites giving the highest number of hits in the global search result.

The invention has been described in terms of specific examples which are illustrative only and are not to be construed as limiting. The invention may be implemented in digital electronic circuitry or in computer hardware, firmware, software, or in combinations of them. Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

From the aforegoing disclosure and certain variations and modifications already disclosed therein for purposes of illustration, it will be evident to one skilled in the relevant art that the present inventive concept can be embodied in forms different from those described and it will be understood that the invention is intended to extend to such further variations. While the preferred forms of the invention have been shown in the drawings and described herein, the invention should not be construed as limited to the specific forms shown and described since variations of the preferred forms will be apparent to those skilled in the art. Thus the scope of the invention is defined by the following claims and their equivalents.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. A search system for enabling local searching via global searching, the system comprising:
a global search engine and a searchable global database storing information relating to web-pages on web-sites and base information relating to one or more web-sites,
a local search engine being accessible based on base information stored in the global database.

2. A search system according to claim 1, wherein the local search engine is remote from the global search engine.

3. A search system according to claim 1, wherein the local search engine runs on the same machine as the web-site being searched by the local search engine.

4. A search system according to claim 1, wherein the local search engine is installed on the same machine as the web-site being searched by the local search engine.

5. A search system according to claim 1, wherein the local search engine is at the same location as the global search engine.

6. A search system according to claim 1, wherein the base information relating to a particular web-site is extracted from a file stored at said particular web-site.

7. A search system according to claim 1, wherein the base information relating to a particular web-site is extracted during crawling of said particular web-site.

8. A search system according to claim 1, wherein the system further comprising means adapted to transfer a search query from the global search engine to a local search engine.

9. A search system according to claim 1, wherein the base information relating to a particular web-site is extended to an existing global data.

10. A search system according to claim 1, further comprising means to launch the local search engine based on base information corresponding to the local search engine and initiated based on a response from a user of the global search engine.

11. A search system according to claim 1, further comprising means to log each time the local search engine is launched, said log comprising a local search engine identifying number.

12. A search system according to claim 1, wherein the local search engine is adapted to redirect a user back to the global search engine after or during execution of the local search engine.

13. A search system according to claim 12, wherein the local search engine comprises means for storing information enabling redirection of a user back to the local search and means for executing said information.

14. A search system according to claim 12, wherein the global search engine is adapted to pass a global search result on to the local search engine, the search result being passed on to the local search engine comprises base information relating to some or all of the web-sites present in a global search result.

15. A search system according to claim 14, wherein the local search engine is adapted to pass the global search result received from the global search engine on to another local search engine.

16. A search system according to claim 1, wherein the base information relating to a particular web-site comprises the path to said web-site and an executable statement which upon execution initiates the local search engine relating to said web-site, said executable statement preferably includes the path to the local search engine.

17. A method for generating a searchable global database useful in a process of carry into effect local searching on a web-site, the method comprising generating and storing in a memory or a storage medium of a computer base information relating to at least one web-site, said base information provides accessibility to a local search engine corresponding to a web-site.

18. A method according to claim 17, wherein the generated information is stored so that base information corresponding to a particular web-site is linked to information relating to web-pages on that particular web-site.

19. A method according to claim 17, wherein the linking is provided by extending base information relating to a particular web-site to information relating to web-pages on that particular web-site.

20. A method according to claim 17, wherein generation of base information corresponding to a particular web-site comprises extracting said base information during crawling of the web-site.

21. A method of effecting local searching on a web-site based on a global search result, the global search result providing information relating to execution of a local search engine adapted to perform search on a web-site, the method comprising
identifying base information relating to a particular web-site, said identifying being based on and initiated by a response provided by a user of the global search engine, and
executing the local search engine based on the identified information.

22. A method according to claim 21, wherein identifying of base information comprises extracting said information from a searchable global database.

23. A method according to claim 21, wherein executing the local search engine comprises supplying the local search engine with a search query submitted to the global search result.

24. A method according to claim 23, wherein executing the identifying information comprises supplying the local search engine with a search query from the global search.

25. A method according claim 21, wherein the method further comprises passing a global search result on to the local search engine.

26. A method according to claim 21 further comprising launching a global search engine after or during execution of a local search engine.

27. A method according to any of the claims 21 further comprising logging in a file each time a local search engine is launched, said logging preferably comprising storing of a local search engine identifying number.
